(19) United States
(12) Patent Application Publication
(10) Pub. No.: US 2021/0341590 A1
(43) Pub. Date: Nov. 4, 2021

(54) SENSOR MODULE, LIDAR SENSOR AND MEANS OF TRANSPORTATION

(71) Applicant: Robert Bosch GmbH, Stuttgart (DE)

(72) Inventors: Joao Oliveira, Fao (PT); Annemarie Holleczek, Ludwigsburg (DE); Mustafa Kamil, Ludwigsburg (DE)

(21) Appl. No.: 17/272,651

(22) PCT Filed: Sep. 4, 2019
(86) PCT No.: PCT/EP2019/073510

§ 371 Date: Apr. 29, 2021

(30) Foreign Application Priority Data
Sep. 7, 2018 (DE) 10 2018 215 228.4

(51) Int. Cl. G01S 7/497; G01S 7/481; G01S 17/931; B60S 1/52; B60S 1/48

(52) U.S. Cl. CPC G01S 7/497; G01S 7/4813; G01S 2007/4977; B60S 1/52; B60S 1/487; G01S 17/931

(57) ABSTRACT

A sensor module for a sensor. The sensor module includes a motor; a housing part including a cover; and a cleaning device. The cleaning device includes a fluid nozzle assembly including a first fluid nozzle, the fluid nozzle assembly being movable along a surface of the cover with the aid of the motor, and being designed to direct a fluid stream onto the surface of the cover.

### FIELD

The present invention relates to a sensor module for a sensor, a LIDAR sensor, and a means of transportation.

### BACKGROUND INFORMATION

Different cleaning systems for sensor covers are currently available. These conventional covers in particular prevent dirt from being able to penetrate into a sensor and damage sensitive parts of the sensor. However, such covers also have the task of allowing sensor signals to pass through. Therefore, the cover in question must be clean to ensure proper functioning of the sensor.

Great Britain Patent Application No. GB 2535862 A1 provides a cleaning film for the cover, the cleaning film being incorporated into the housing of the optical sensor.

German Patent Application No. DE 102016006039 A1 provides two wiper elements that are in mechanical contact with the cover and that rotationally clean it.

In addition, integrated heating wires for defrosting and dehumidifying a cover are known (cf. German Patent Application Nos. DE 102011122345 A1 and DE 102014114363 A1, and U.S. Patent Application Publication No. US 2017/3344397 A1).

### SUMMARY

According to a first aspect, the present invention relates to a sensor module for a sensor. A “sensor module” may be understood here to mean a component or an assembly of a sensor. In the present context, a “sensor” is understood in particular to mean an ultrasonic sensor and/or a LIDAR sensor and/or a camera sensor and/or an Li cam sensor and/or a radar sensor. The sensor module includes in particular a housing part including a cover, as defined at the outset, which may include glass and/or polycarbonate and/or PMMA. In addition, the sensor module includes a cleaning device. This cleaning device includes a fluid nozzle assembly. With the aid of this fluid nozzle assembly it is possible, using a compressor, for example, for ambient air to be taken in and introduced under pressure into a first fluid nozzle contained in the fluid nozzle assembly. With the aid of the first fluid nozzle, increased flow speeds necessary for the cleaning may be applied due to the Bernoulli effect. This fluid nozzle assembly is movable along a surface of the cover with the aid of a motor. In addition, the fluid nozzle assembly is designed to direct a fluid stream (for example, a gas, in particular ambient air, and/or water and/or an aerosol) onto the surface of the cover. In other words, the fluid nozzle assembly may be moved with the aid of the motor, for example an electric motor, in such a way that the fluid nozzle assembly may direct a fluid stream, via the first fluid nozzle, onto any point of the surface of the cover. Dirt particles situated on the surface may thus be removed by the fluid stream, which has high flow speeds due to the Bernoulli effect. For example, compressed air, which is directed from the first fluid nozzle onto the surface of the cover, may be used to remove solid dirt particles such as dust from the surface, and thus to clean these particles from the surface. In particular, solidified dirt may be removed with the aid of an aerosol and/or a liquid that are/is directed onto the surface by the fluid nozzle. Due to the motorized movability of the fluid nozzle assembly along the entire surface of the cover, it is thus possible to efficiently remove dirt at any point of the cover. In this way, a contactless cleaning mechanism is possible in which scratching or abrasion of the surface of the cover is avoided. The service life of a surface of a cover, in particular a coating on this surface, may thus be increased. In addition, as the result of a fluid stream that is applied to the surface, in particular in the case of a gas stream, the surface of the cover may be dehumidified. Accordingly, due to the present invention a universal module that is suited for cleaning a plurality of sensors may be provided. Furthermore, the fluid nozzle assembly may also include a second or third or fourth fluid nozzle, etc., in addition to a first fluid nozzle.

Advantageous refinements and embodiments of the present invention are described herein.

According to one advantageous refinement of the present invention, the first fluid nozzle includes a first outlet opening. This first outlet opening may have a punctiform design, for example. As the result of a punctiform design, a fluid stream may be directed onto a point of the surface of the cover, including dirt particles, in a targeted manner. The locality of the dirt particle may be determined with the aid of a camera, for example, which in particular may be situated on the cleaning device and may detect the surface of the cover. Additionally or alternatively, the outlet opening may be linear. A larger area of the surface of the cover glass may be cleaned by use of such a linear nozzle. Due to the additional movement of the fluid nozzle or the fluid nozzle assembly via the motor, a large portion of the surface may be quickly and efficiently cleaned with the aid of a linear outlet opening.

In a further advantageous embodiment of the present invention, the first fluid nozzle includes a second outlet opening that is designed to direct the fluid stream onto the surface of the cover. The first outlet opening points in a different direction than the second outlet opening. For example, an angle that is defined by the directions in which the first and second outlet openings point may be 30° to 90°, in particular 30° to 60°. When an area of the surface of the cover is to be cleaned, a first distance of the fluid nozzle along this area may be covered, the fluid stream being led out from only the first outlet opening. The blocking of the fluid stream from the second outlet opening may take place in particular via a valve circuit. In this scenario, in particular for a return path of the covered distance, the fluid stream may be blocked in such a way that a fluid stream is no longer directed onto the surface from the first outlet opening, and in turn a fluid stream is directed onto the area from the second outlet opening during the “return path.” This has the advantage of increased efficiency of the cleaning effect, since during the movement of the nozzle with the aid of the motor, an optimal flow cross section of the cover may be continually directed, at an optimal angle of the fluid stream, onto the surface or the area that is to be cleaned.

According to a further advantageous embodiment of the sensor module according to the present invention, the first fluid nozzle is also configured to direct the fluid stream onto the cover at an angle of 30° to 60° with respect to the surface normal of the cover. The angle is particularly preferably 30° to 45°. The fluid stream generated by the nozzle or the Bernoulli effect may thus be directed onto the surface at an optimal angle with respect to the dirt particles, thus further optimizing the cleaning effect. At an angle less than 30°, the fluid stream is merely blown onto the dirt particles or the dirt in a nonideal manner, thus reducing the likelihood of removing the particles. At an angle greater than 60°, in particular there is an increased risk of an excessively large flow cross section of the generated fluid stream moving past the surface instead of achieving the desired cleaning effect.

In a further advantageous embodiment of the sensor module according to the present invention, a cross section of the first fluid nozzle that tapers toward the first outlet opening may be triangular or circular. In particular, the first or second outlet opening may likewise have this cross section. This ensures in particular a pressure homogenization along the outlet opening.

According to a further advantageous embodiment of the present invention, the first fluid nozzle may be moved on a straight and/or curved path with the aid of the motor. The sensor module according to the present invention may thus be optimally adapted to any shape of a surface of a cover (concave and/or convex and/or planar and/or angled, for example).

According to one advantageous refinement of the sensor module according to the present invention, the first fluid nozzle may be designed to carry out a self-rotation with the aid of the motor. In addition to the movement along the surface, the fluid nozzle may thus be optimally oriented at an angle with respect to the surface orthogonal of the surface of the cover, so that the number of outlet openings or the number of fluid nozzles may be kept small.

In a further advantageous embodiment of the sensor module according to the present invention, the cleaning device may also include a heating device that is designed to control the temperature of the fluid stream. Such temperature control may be provided, for example, by a heat exchanger and/or heating wires in the supply channel to the fluid nozzle. In addition, such a heating device, for example likewise in the form of electrically heatable heating wires, may be situated directly at the outlet opening. Due to the temperature control of the fluid stream, in particular steam may be directed onto the surface of the cover for a better cleaning effect, for example in the case of stuck dirt. Moreover, for example in the case of heated air, the fluid stream may be used to defrost a cover. Thus, in addition to the cleaning effect of the sensor module according to the present invention, an improved removal of stuck dirt or frost is also possible.

The following aspects according to the present invention include the advantageous embodiments and refinements having the above-mentioned technical features, as well as the general advantages of the assembly according to the present invention and the associated technical effects in each case. Therefore, a relisting is omitted in the following in order to avoid repetitions.

According to a second aspect, the present invention relates to a LIDAR sensor that includes a sensor module according to the first aspect of the present invention. In the present case, the cover is in particular a window of the LIDAR sensor which is configured to allow LIDAR-specific radiation to pass through.

According to a third aspect, the present invention relates to a means of transportation that includes a LIDAR sensor according to the second aspect of the present invention. Within the meaning of the present invention, for example automobiles, in particular passenger automobiles and/or trucks, and/or aircraft and/or ships and/or motorcycles, are suitable as means of transportation.

### BRIEF DESCRIPTION OF THE DRAWINGS

Exemplary embodiments of the present invention are described in greater detail below with reference to the figures.

FIG. 1 shows one specific embodiment of the LIDAR sensor according to the present invention.

FIG. 2 shows an illustration of one specific embodiment of a fluid nozzle of the sensor module according to the present invention.

FIG. 3 shows an illustration of a taper of a cross section of one specific embodiment of a fluid nozzle of the sensor module according to the present invention.

FIG. 4 shows one specific embodiment of the means of transportation according to the present invention.

### DETAILED DESCRIPTION OF EXAMPLE EMBODIMENTS

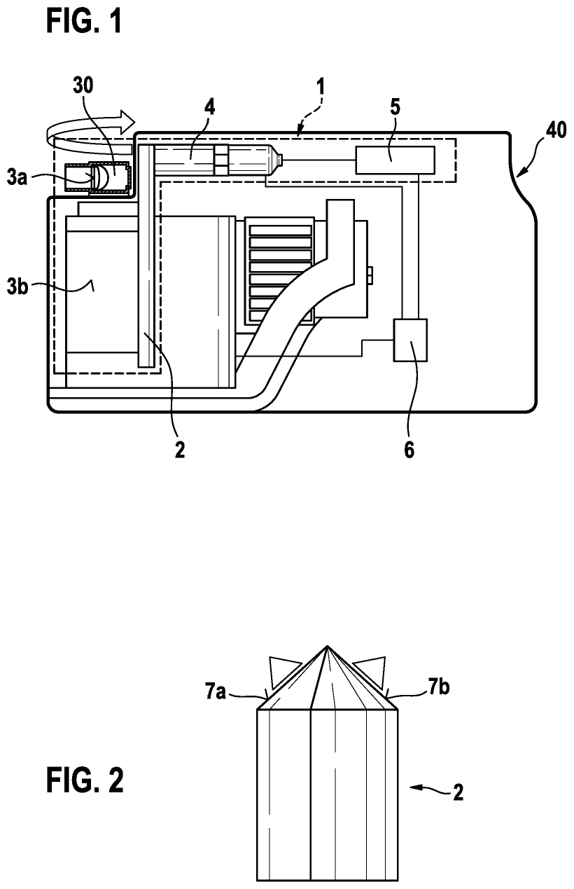

FIG. 1 shows one specific embodiment of a LIDAR sensor 40 according to the present invention which includes a sensor module 1 according to the present invention. In addition, a camera 30 may be combined with LIDAR sensor 40 for sensor module 1 according to the present invention. Sensor module 1 according to the present invention includes a first fluid nozzle 2. In addition, the LIDAR sensor includes a second surface 3b of the cover via which the LIDAR radiation may exit. Furthermore, the camera includes a first surface 3a of the cover, the cover in the present case being a camera lens in particular. First and second surfaces 3a, 3b may be cleaned by a fluid stream that is directed onto these surfaces 3a, 3b by first fluid nozzle 2. In particular, motor 4 may guide first fluid nozzle 2, which in particular has a linear design along the length of fluid nozzle 2, along first and second surfaces 3a, 3b in a circular path, as demonstrated by the curved arrow. A fluid stream may thus be directed onto any point of surfaces 3a, 3b. In particular, the functions of sensor module 1 according to the present invention as well as those of camera 30 and of LIDAR sensor 40 may be controlled by an evaluation unit 6.

FIG. 2 illustrates one specific embodiment of first fluid nozzle 2 of sensor module 1 according to the present invention. First fluid nozzle 2 includes a first outlet opening 7a and a second outlet opening 7b. These outlet openings 7a, 7b point in different directions, as shown by the triangular arrows. First fluid nozzle 2 may thus be guided by motor 4 in such a way that during an outbound path across second surface 3b of the cover of LIDAR sensor 40, the fluid stream is guided solely from first outlet opening 7a in the direction of the left arrow. Second outlet opening 7b, whose direction is indicated by the right arrow, may be appropriately blocked by a valve. If first fluid nozzle 2 is to be returned via the same path, first outlet opening 7a may be deactivated while second outlet opening 7b is activated, as the result of which a fluid stream may exit onto second surface 3b of the LIDAR sensor in the direction of the right arrow. Thus, fluid may be optimally directed onto first and/or second surface 3a, 3b of camera 30 and of LIDAR sensor 40 when second fluid nozzle 2 from FIG. 2 is considered in conjunction with FIG. 1. The outbound path is illustrated by the curved arrow, while the return path extends in the direction opposite the curved arrow.

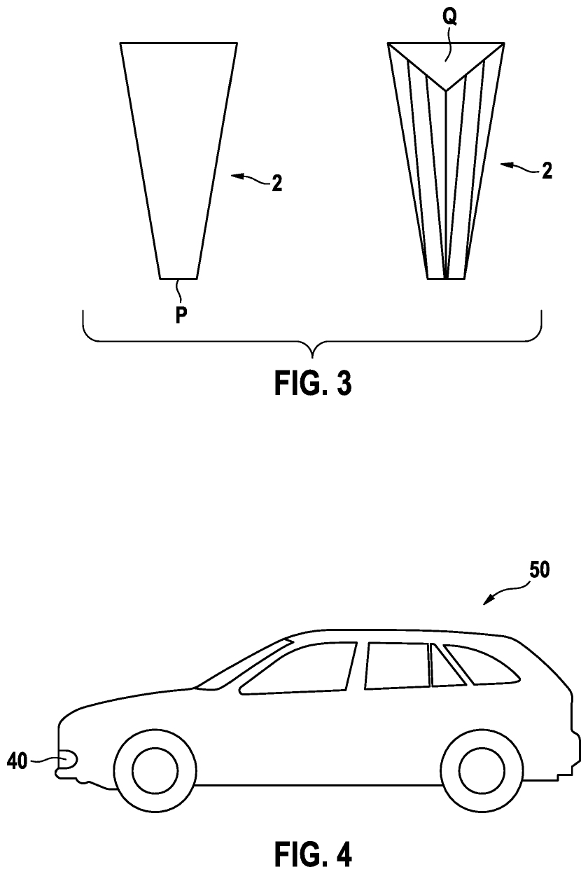

FIG. 3 shows a profile P of a tapering cross section of first fluid nozzle 2 according to the present invention, while tapering cross section Q is shown in a triangular shape in the illustration on the right.

FIG. 4 shows a means of transportation (e.g., a transportation vehicle) 50 according to the present invention which includes a LIDAR sensor 40 according to the present invention.

1-10. (canceled)

11. A sensor module for a sensor, the sensor module comprising:
a motor;
a housing part including a cover; and
a cleaning device, the cleaning device including a fluid nozzle assembly including a first fluid nozzle, the fluid nozzle assembly being movable along a surface of the cover using the motor, and being configured to direct a fluid stream onto the surface of the cover.

12. The sensor module as recited in claim 11, wherein the first fluid nozzle includes a first outlet opening, the outlet opening being punctiform and/or linear.

13. The sensor module as recited in claim 12, wherein the first fluid nozzle includes a second outlet opening that is designed to direct a fluid stream onto the surface of the cover, the first outlet opening and the second outlet opening pointing in different directions relative to one another.

14. The sensor module as recited in claim 11, wherein the first fluid nozzle is also configured to direct the fluid stream onto the surface of the cover at an angle of 30° to 60° with respect to a surface normal of the cover.

15. The sensor module as recited in claim 12, wherein a cross section of the first fluid nozzle that tapers toward the first outlet opening is triangular or circular.

16. The sensor module as recited in claim 11, wherein the first fluid nozzle is movable on a straight and/or curved path using the motor.

17. The sensor module as recited in claim 11, wherein the first fluid nozzle is configured to carry out a self-rotation using the motor.

18. The sensor module as recited in claim 11, wherein the cleaning device also includes a heating device that is configured to control a temperature of the fluid stream.

19. A LIDAR sensor, comprising:
a sensor module for the LIDAR sensor, the sensor module including:
a motor,
a housing part including a cover, and
a cleaning device, the cleaning device including a fluid nozzle assembly including a first fluid nozzle, the fluid nozzle assembly being movable along a surface of the cover using the motor, and being configured to direct a fluid stream onto the surface of the cover.

20. A transportation vehicle, comprising:
a LIDAR sensor, including:
a sensor module for the LIDAR sensor, the sensor module including:
a motor,
a housing part including a cover, and
a cleaning device, the cleaning device including a fluid nozzle assembly including a first fluid nozzle, the fluid nozzle assembly being movable along a surface of the cover using the motor, and being configured to direct a fluid stream onto the surface of the cover.
